(19) United States
(12) Patent Application Publication
(10) Pub. No.: US 2013/0127962 A1
(43) Pub. Date: May 23, 2013

(54) IMAGE RECORDING DEVICE, IMAGE RECORDING METHOD

(71) Applicant: SEIKO EPSON CORPORATION, Tokyo (JP)

(72) Inventor: Kaneo YODA, Okaya (JP)

(73) Assignee: SEIKO EPSON CORPORATION, Tokyo (JP)

(21) Appl. No.: 13/680,735

(22) Filed: Nov. 19, 2012

(30) Foreign Application Priority Data
Nov. 21, 2011 (JP) 2011-253864

(51) Int. Cl. B41J 13/00

(52) U.S. Cl. CPC B41J 13/0009
USPC 347/102

(57) ABSTRACT

An image recording device includes: a conveyor unit for conveying a recording medium; a drum for rotating under the force of friction against the recording medium being conveyed by the conveyor unit, the recording medium being wound around an outer peripheral surface thereof; an ejection unit for ejecting a photo-curable ink to record an image on a portion, of the recording medium, that is wound around the drum; a light irradiation unit for irradiating the portion, of the recording medium, that is wound around the drum with light to cure the ink on the recording medium, downstream of the recording medium on a conveyance path with respect to the ejection unit; and a cooling unit for cooling the drum.

### CROSS-REFERENCE TO RELATED APPLICATIONS

This application claims priority to Japanese Patent Application No. 2011-253864 filed on Nov. 21, 2011. The entire disclosure of Japanese Patent Application No. 2011-253864 is hereby incorporated herein by reference.

### BACKGROUND

1. Technical Field

The present invention relates to a technique for recording an image by curing, by light irradiation, a photo-curable ink ejected onto a recording medium.

2. Background Technology

Patent Citation 1 describes a printer for recording an image by ejecting ink onto a recording medium being conveyed along a conveyance direction, the recording medium being arranged so as to face an outer peripheral surface of a conveyance drum, while the recording medium is being supported by the conveyance drum. In particular with the printer of such description, an ink that is cured by being irradiated with ultraviolet rays (a UV ink) is used, and the ink having been ejected onto the recording medium is affixed to the recording medium by curing under the irradiation with the ultraviolet rays.

Japanese Laid-open Patent Publication No. 2011-016313 (Patent Document 1) is an example of the related art.

### SUMMARY

### Problems to be Solved by the Invention

However, a photo-curable ink, which is cured by being irradiated with light, as with the UV ink described above, generates heat in association with the curing reaction, and also generates heat due to the absorption of the light. As such, the temperature of the portion on the recording medium where the ink is affixed will be higher than the temperature of the other portions. Also, when such a temperature distribution becomes more prominent, there arises a considerable difference in the contraction of the recording medium between the high-temperature portion and the low-temperature portion, and in some cases wrinkling has occurred in the recording medium. In such a case, it is possible that there will be a decline in the quality of the image, such as in that there will be an unevenness in terms of the glossiness of the image, that there will be a change in texture such as being gloss or matte, or that there will be a change in the color tone.

It is an advantage of the invention, which has been contrived in view of the foregoing problems, to provide an image recording technology for making it possible to keep low the temperature distribution in a recording medium, to suppress the occurrence of wrinkling in a recording medium, and to obtain a high-quality image.

### Means Used to Solve the Above-Mentioned Problems

In order to achieve the foregoing advantage, the image recording device according to the invention includes: a conveyor unit for conveying a recording medium; a drum for rotating under the force of friction against the recording medium being conveyed by the conveyor unit, the recording medium being wound around an outer peripheral surface thereof; an ejection unit for ejecting a photo-curable ink to record an image on a portion, of the recording medium, that is wound around the drum; a light irradiation unit for irradiating the portion, of the recording medium, that is wound around the drum with light to cure the ink on the recording medium, downstream of the recording medium on a conveyance path with respect to the ejection unit; and a cooling unit for cooling the drum.

In order to achieve the foregoing advantage, the image recording method according to the invention is an image recording method in which photo-curable ink is ejected onto a recording medium to record an image, while the recording medium is also being conveyed, and thereafter the recording medium is irradiated with light to cure the ink on the recording medium, the image recording method being characterized in that a drum that rotates under the force of friction against the recording medium is cooled while a portion of the recording medium onto which the ink is ejected and a portion thereof that is irradiated with light are wound around and supported by an outer peripheral surface of the drum.

In the invention configured in this fashion (the image recording device and the image recording method), the recording medium is wound around and supported by the drum that rotates under the force of friction against the recording medium. In the configuration of such description, because the drum supporting the recording medium rotates while following the conveyance of the recording medium, the infiltration of air in between the drum and the recording medium being thus conveyed can be suppressed, and the recording medium can be closely contacted with the drum at the portion wound about the drum. Also, because the drum is cooled, the heat of the recording medium can be transmitted to the drum via the portion wound about and closely contacted with the drum. In addition, in the invention, the photo-curable ink is cured by being irradiated with light at the portion, of the recording medium, that is wound about the drum. As such, the heat that is generated by the ink in association with the curing by light irradiation can be rapidly released to the drum via the portion, of the recording medium, that is wound about the drum. Accordingly, the temperature elevation in the portion of the recording medium where the ink has been affixed can be reduced and the temperature distribution in the recording medium can be kept low; as a result, it becomes possible to suppress the occurrence of wrinkling in the recording medium, and to obtain a high-quality image.

Herein, the image recording device can be configured such that the cooling unit cools a non-winding portion of the outer peripheral surface of the drum, where the recording medium is not wound therearound. The configuration of such description makes it possible to cool the drum without the recording medium being interposed, and thus makes it possible to cool the drum in an efficient fashion.

Herein, the image recording device can be configured such that the cooling unit blows air with a fan onto the non-winding portion of the outer peripheral surface of the drum to cool the drum. Alternatively, the image recording device can be configured such that the cooling unit has a contact roller that is in contact with the non-winding portion of the outer peripheral surface of the drum, and uses the contact roller to cool the drum. More specifically, the image recording device could be configured such that the cooling unit cools the drum using heat piping mounted onto the contact roller, or the image recording device could be configured such that the cooling unit coats the non-winding portion of the outer peripheral surface of the drum with a liquid using the contact roller and thereby cools the drum.

The image recording device can be configured so as to be further provided with a temperature detection unit for detecting the temperature of the recording medium having been irradiated with light by the light irradiation unit. Alternatively, the image recording device can be configured so as to be further provided with a temperature detection unit for detecting the temperature of the non-winding portion of the outer peripheral surface of the drum. In addition, the image recording device can be configured so as to be further provided with a control unit for controlling a cooling operation of the drum by the cooling unit, on the basis of a detection result from the temperature detection unit. More specifically, the image recording device can be configured such that the control unit causes the cooling unit to execute the cooling of the drum in a case where the detection result from the temperature detection unit reaches a predetermined temperature or higher. In other words, the cooling of the drum need not be carried out at all times, but rather the cooling of the drum can be stopped in a case where the temperature of the drum is adequately low to such an extent that heat will be dissipated from the recording medium to the drum, whereas the cooling of the drum would then be carried out in a case where the temperature of the drum has reached the predetermined temperature or higher. With the configuration of such description, the cooling of the drum will not be performed unnecessarily, and the effect of successfully conserving power can be expected.

The image recording device can be configured such that the cooling unit is constituted of fins mounted onto the drum side by side in the peripheral direction of the drum. Namely, as described above, the drum rotates in association with the conveyance of the recording medium. As such, when the fins have been mounted onto the drum side by side in the peripheral direction of the drum, the fins, which rotate together with the drum, cut through the surrounding air, and thus it is possible to promote the dissipation of heat from the fins and to effectively cool the drum.

Herein, the image recording device can be configured such that the drum is formed so as to be hollow, and the fins are arranged on an inner wall of the drum. With the configuration of such description, there is no need for an arrangement space for the fins to be provided to the outside of the drum, and thus the image recording device can be successfully reduced in size.

The image recording device can also be configured such that the cooling unit has a fan for blowing air into the hollow portion of the drum. This makes it possible to create an air flow in the hollow portion of the drum to which the fins are provided, and thus possible to further promote the dissipation of heat from the fins and to even more effectively cool the drum. It should also be noted that in the case where the fan of such description is provided, the image recording device can be configured so as to be further provided with a temperature detection unit for detecting the temperature of the inner wall of the drum, and a control unit for controlling the air-blowing of the fan of the cooling unit on the basis of a detection result from the temperature detection unit. This makes it possible for the fan to be operated as appropriate in accordance with the temperature of the inner wall of the drum, to effectively cool the drum.

When, as described above, the recording medium is closely contacted with the drum and heat is dissipated from the recording medium to the drum, then, preferably, a uniform tension is applied to the recording medium to enhance the close contact between the recording medium and the drum. However, in some cases when the recording medium is misaligned in the orthogonal direction, which is orthogonal to the conveyance path, the tension being applied to the recording medium is thereby distributed in the orthogonal direction.

In view whereof, the image recording device can also be configured so as to be further provided with: a plurality of tension detection units for detecting the tension of the recording medium at respective, mutually different positions, at which the tension detection units are arranged, in the orthogonal direction orthogonal to the conveyance path of the recording medium; and a position adjustment mechanism for adjusting the position of the recording medium in the orthogonal direction, on the basis of a detection result from each of the tension detection units. With the configuration of such description, a misalignment of the recording medium in the orthogonal direction can be corrected as appropriate, and the distribution of tension of the recording medium in the orthogonal direction can be suppressed. As such, the close contact between the recording medium and the drum can be enhanced, and the distribution of heat from the recording medium to the drum can be promoted; as a result, it becomes possible to suppress the occurrence of wrinkling in the recording medium, and to obtain a high-quality image.

In order to achieve the foregoing advantage, the image recording device according to the invention includes: a conveyor unit for conveying a recording medium; a drum which is rotatably supported in a state where a predetermined tension has been applied to the recording medium and is rotated and driven so as to be synchronous with the recording medium, the recording medium being wound around the outer peripheral surface thereof; an ejection unit for ejecting a photo-curable ink to record an image on a portion, of the recording medium, that is wound around the drum; a light irradiation unit for irradiating the portion, of the recording medium, that is wound around the drum with light to cure the ink on the recording medium, downstream of the recording medium on a conveyance path with respect to the ejection unit; and a cooling unit for cooling the drum.

In the invention configured in this fashion (the image recording device and the image recording method), the drum for supporting the recording medium is rotatably supported and rotates so as to be synchronous with the conveyance of the recording medium, in a state where the predetermined tension has been applied, the recording medium being wound around the outer peripheral surface of the drum. In the configuration of such description, when the drum supporting the recording medium rotates synchronously with the conveyance of the recording medium, the infiltration of air in between the drum and the recording medium being thus conveyed can be suppressed, and the recording medium can be closely contacted with the drum at the portion wound about the drum. Also, because the drum is cooled, the heat of the recording medium can be transmitted to the drum via the portion wound about and closely contacted with the drum. In addition, in the invention, the photo-curable ink is cured by being irradiated with light at the portion, of the recording medium, that is wound about the drum. As such, the heat that is generated by the ink in association with the curing by light irradiation can be rapidly released to the drum via the portion, of the recording medium, that is wound about the drum. Accordingly, the temperature elevation in the portion of the recording medium where the ink has been affixed can be reduced and the temperature distribution in the recording medium can be kept low; as a result, it becomes possible to suppress the occurrence of wrinkling in the recording medium, and to obtain a high-quality image.

### BRIEF DESCRIPTION OF THE DRAWINGS

Referring now to the attached drawings which form a part of this original disclosure:

FIG. 1 is a drawing schematically illustrating an example of a device configuration provided to a printer to which the invention can be applied;

FIG. 2 is a drawing schematically illustrating an electrical configuration for controlling the printer illustrated in FIG. 1;

FIG. 3 is a drawing schematically illustrating an example of the arrangement of a tension sensor;

FIG. 4 is a drawing schematically illustrating an example of a device configuration provided to a printer as in a second embodiment;

FIG. 5 is a drawing schematically illustrating an example of a device configuration provided to a printer as in a third embodiment;

FIG. 6 is a drawing schematically illustrating a modification example of a cooling mechanism for a platen drum; and

FIG. 7 is a drawing schematically illustrating another modification example of the cooling mechanism for the platen drum.

### DETAILED DESCRIPTION OF EXEMPLARY EMBODIMENTS

### First Embodiment

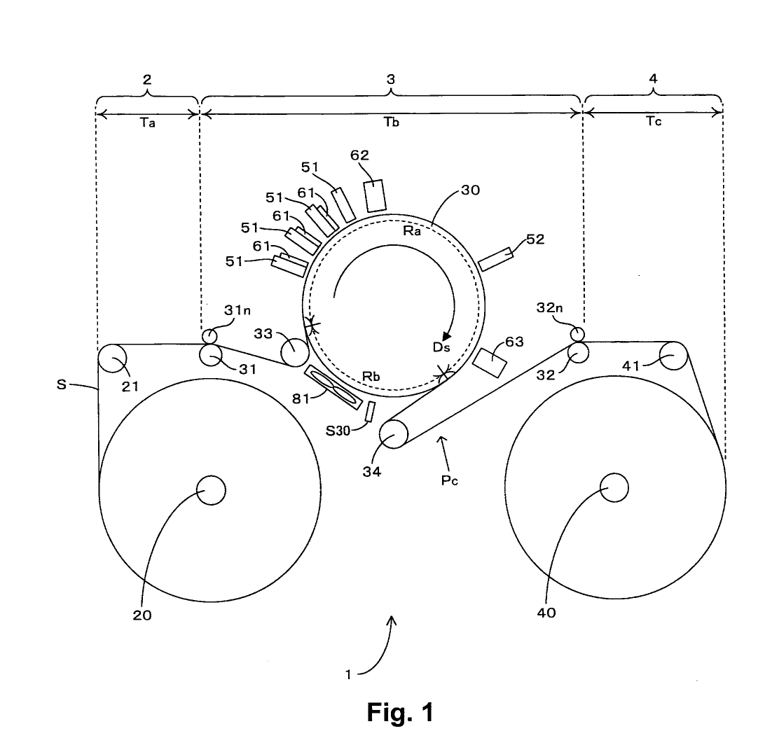

FIG. 1 is a front view schematically illustrating an example of a device configuration provided to a printer to which the invention can be applied. As illustrated in FIG. 1, in a printer 1, a single sheet S (web) having two ends that have been wound in a roll-shaped fashion around a supply spindle 20 and a take-up spindle 40 is stretched between the supply spindle 20 and the take-up spindle 40, and the sheet S is conveyed from the supply spindle 20 to the take-up spindle 40 along a path Pc having been thus stretched. In the printer 1, an image is recorded onto the sheet S being conveyed along the conveyance path Pc. The type of sheet S is largely divided into paper-based and film-based. As specific examples, paper-based includes high-quality paper, cast paper, art paper, coated paper, and the like, while film-based includes synthetic paper, PET (Polyethylene terephthalate), PP (polypropylene), and the like. In brief, the printer 1 is provided with: a supply unit 2 for supplying the sheet S from the supply spindle 20; a process unit 3 for recording an image onto the sheet S having been supplied from the supply unit 2; and a take-up unit 4 for taking up, around the take-up spindle 40, the sheet S on which the image has been recorded by the process unit 3. In the following description, whichever side of the two sides of the sheet S is the one on which the image is recorded is referred to as the “front surface”, while the side opposite thereto is referred to as the “back surface”.

The supply unit 2 has the supply spindle 20, around which an end of the sheet S has been wound, as well as a driven roller 21 around which is wound the sheet S having been drawn out from the supply spindle 20. The supply unit 20 supports the end of the sheet S wound therearound in a state where the front surface of the sheet S faces outward. When the supply spindle 20 is rotated in the clockwise direction in FIG. 1, the sheet S having been wound around the supply spindle 20 is thereby made to pass via the driven roller 21 and supplied to the process unit 3. It should also be noted that the sheet S is wound about the supply spindle 20 with a core tube (not shown) therebetween, the core tube being detachable with respect to the supply spindle 20. As such, when the sheet S of the supply spindle 20 has been exhausted, it is possible for a new core tube around which a roll of the sheet S has been wound to be mounted onto the supply spindle 20, to replace the sheet S of the supply spindle 20.

The process unit 3 is intended to record an image onto the sheet S by carrying out a process, as appropriate, using functional units 51, 52, 61, 62, 63 arranged along the outer peripheral surface of a platen drum 30 while the platen drum 30 supports the sheet S having been supplied from the supply unit 2. In the process unit 3, a front drive roller 31 and a rear drive roller 32 are provided on two ends of the platen drum 30, and the sheet S, which is conveyed from the front drive roller 31 to the rear drive roller 32, is supported on the platen drum 30 and undergoes image recording.

The front drive roller 31 has on the outer peripheral surface a plurality of minute projections formed by thermal spraying, and the sheet S having been supplied from the supply unit 2 is wound around from the back surface side. When the front drive roller 31 is rotated in the clockwise direction in FIG. 1, the sheet S having been supplied from the supply unit 2 is thereby conveyed downstream on the conveyance path. A nip roller 31n is provided to the front drive roller 31. The nip roller 31n is urged toward the front drive roller 31 side and in this state abuts against the front surface of the sheet S, and sandwiches the sheet S with the front drive roller 31 on the other side. This ensures the force of friction between the front drive roller 31 and the sheet S, and makes it possible for the front drive roller 31 to reliably convey the sheet S.

The platen drum 30 is a cylindrically-shaped drum rotatably supported by a support mechanism (not shown), and the sheet S being conveyed from the front drive roller 31 to the rear drive roller 32 is wound therearound from the back surface side. The platen drum 30 is intended to support the sheet S from the back surface side while also reciprocatingly rotating in a conveyance direction Ds of the sheet S, under the force of friction against the sheet S. It should also be noted that in the process unit 3, driven rollers 33, 34 for folding the sheet S on both sides of a section wound around the platen drum 30 are provided. Of these, the driven roller 33 folds the sheet S with the front surface of the sheet S wound between the front drive roller 31 and the platen drum 30. On the other hand, the driven roller 34 folds the sheet S with the front surface of the sheet S wound between the platen drum 30 and the rear drive roller 32. In this manner, the sheet S is folded upstream and downstream of the platen drum 30 in the conveyance direction Ds, whereby the length of the wound section of the sheet S on the platen drum 30 can be ensured.

The rear drive roller 32 has on the outer peripheral surface a plurality of minute projections formed by thermal spraying, and the sheet S having been conveyed from the platen drum 3 via the driven roller 34 is wound therearound from the back surface side. When the rear drive roller 32 is rotated in the clockwise direction in FIG. 1, the sheet S is thereby conveyed toward the take-up unit 4. A nip roller 32n is provided to the rear drive roller 32. This nip roller 32 is urged toward the rear drive roller 32 and in this state abuts against the front surface of the sheet S, and sandwiches the sheet S with the rear drive roller 32 on the other side. This ensures the force of friction between the rear drive roller 32 and the sheet S, and makes it possible for the rear drive roller 32 to reliably convey the sheet S.

In this manner, the sheet S being conveyed from the front drive roller 31 to the rear drive roller 32 is supported on the outer peripheral surface of the platen drum 30. Also, with the process unit 3, in order to record a color image onto the front surface of the sheet S being supported on the platen drum 30, a plurality of recording heads 51 corresponding to mutually different colors are provided. Specifically, four recording heads 51 corresponding to yellow, cyan, magenta, and black are lined up in the stated order of colors in the conveyance direction Ds. Each of the recording heads 51 faces the front surface of the sheet S wound around the platen drum 30, with a certain amount of clearance therebetween, and ejects ink of the corresponding color in an ink jet scheme. When each of the recording heads 51 ejects ink onto the sheet S being conveyed toward the conveyance direction Ds, a color image is thereby formed on the front surface of the sheet S.

It should be noted that the ink used is a UV (ultraviolet) ink that is cured by being irradiated with ultraviolet rays (light) (i.e., is a photo-curable ink). In view whereof, with the process unit 3, in order to cure the ink and affix same to the sheet S, UV lamps 61, 62 (light irradiation units) are provided. The execution of this curing of the ink is divided into two stages, which are temporary curing and true curing. A UV lamp 61 for temporary curing is arranged between each of the plurality of recording heads 51. Namely, the UV lamp 61 is intended to irradiate with weak ultraviolet rays and thereby cure the ink to such an extent that the shape of the ink is not lost (temporary curing), and is not intended to fully cure the ink. On the other hand, a UV lamp 62 for true curing is provided downstream in the conveyance direction Ds with respect to each of the plurality of recording heads 51. Namely, the UV lamp 62 irradiates with stronger ultraviolet rays than the UV lamp 61 and is intended to thereby fully cure the ink (true curing). Executing the temporary curing and true curing in this manner makes it possible to affix onto the front surface of the sheet S the color image formed by the plurality of recording heads 51.

Also, a recording head 52 is provided downstream in the conveyance direction Ds with respect to the UV lamp 62. This recording head 52 faces the front surface of the sheet S wound around the platen drum 30, with a certain amount of clearance therebetween, and ejects a transparent UV ink onto the front surface of the sheet S in an ink jet scheme. In other words, the transparent ink is additionally ejected onto the color image formed by the recording heads 51 of the four different colors. A UV lamp 63 is also provided downstream in the conveyance direction Ds with respect to the recording head 52. This UV lamp 63 irradiates with strong ultraviolet rays and is intended to thereby fully cure (true curing) the transparent ink having been ejected by the recording head 52. This makes it possible to affix the transparent ink onto the front surface of the sheet S.

As described above, the sheet S is wound about and supported by the platen drum 30. In order to cure the UV ink having impacted onto the surface of the sheet S, the sheet S having been wound around a winding section Ra of the outer peripheral surface of the platen drum 30 in this manner is irradiated with ultraviolet rays. Then, in the process unit 3, in order to suppress the elevation in the temperature of the UV ink at this time, a configuration is adopted such that the platen drum 30 is cooled and heat generated by the UV ink is released to the platen drum 30.

Specifically, a cooling fan 81 is arranged so as to face a release section Rb (a non-winding portion) of the outer peripheral surface of the platen drum 30 where the sheet S is not wound therearound. The cooling fan 81 blows onto the outer peripheral surface of the platen drum 30, which is exposed at the release section Rb, and thus cools the platen drum 30. In order to increase the cooling efficiency herein, it would be possible to use a platen drum 30 made of a metal such as copper or aluminum.

With the process unit 3, this manner of ejecting and curing ink is executed as appropriate on the sheet S wound about the outer peripheral part of the platen drum 30, and a color image coated with the transparent ink is formed. Also, the sheet S on which the color image has been formed is conveyed toward the take-up unit 4 by the rear drive roller 32.

In addition to the take-up spindle 40 around which an end of the sheet S is wound, the take-up unit 4 also has a driven roller 41 around which the sheet S is wound from the back surface side between the take-up spindle 40 and the rear drive roller 32. The take-up spindle 40 supports one end of the sheet S taken up therearound in a state where the front surface of the sheet S is facing outward. Namely, when the take-up spindle 40 is rotated in the clockwise direction in FIG. 1, the sheet S, which has been conveyed from the rear drive roller 32, passes through the driven roller 41 and is taken up around the take-up spindle 40. It also should be noted that the sheet S is taken up around the take-up spindle 40 with a core tube (not shown) therebetween, the core tube being detachable with respect to the take-up spindle 40. As such, when the sheet S taken up around the take-up spindle 40 has been exhausted, it becomes possible to remove the sheet S in an amount commensurate with the core tube.

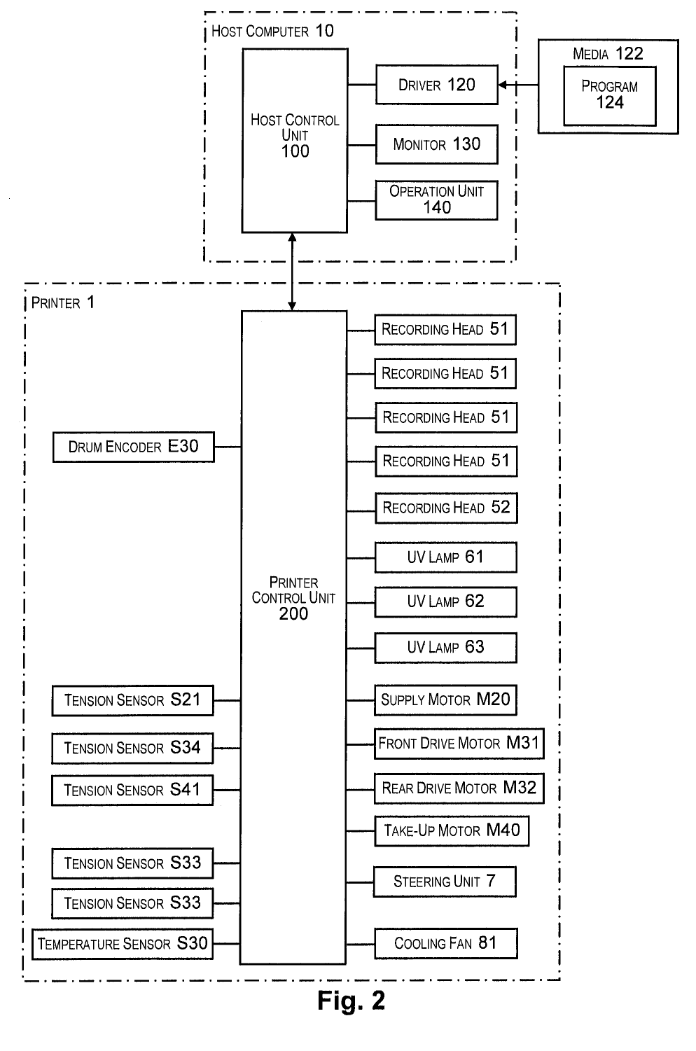

The foregoing is a summary of the device configuration of the printer 1. The following description shall relate to the electrical configuration for controlling the printer 1. FIG. 2 is a block diagram schematically illustrating the electrical configuration for controlling the printer illustrated in FIG. 1. The operation of the printer 1 described above is controlled by a host computer 10 illustrated in FIG. 2. With the host computer 10, a host control unit 100 for governing all control operations is constituted of a CPU (Central Processing Unit) and a memory. A driver 120 is also provided to the host computer 10, and this driver 120 reads out a program 124 from media 122. The media 122 can be a variety of different things, such as a CD (Compact Disk), DVD (Digital Versatile Disk), or USB (Universal Serial Bus) memory. The host control unit 100 also controls each of the parts of the host computer 10 and controls the operation of the printer 1, on the basis of the program 124 having been read out from the media 122.

A monitor 130 constituted of a liquid crystal display or the like and an operation unit 140 constituted of a keyboard, mouse, or the like are provided to the host computer 10 as interfaces for interfacing with an operator. In addition to an image to be printed, a menu screen is also displayed on the monitor 130. As such, by operating the operation unit 140 while also checking the monitor 130, the operator is able to open up a print setting screen from the menu screen and set the type of printing medium, the size of printing medium, the quality of printing, and a variety of other print conditions. A variety of modifications could be made to the specific configuration of the interface for interfacing with the operator; for example, a touch panel-type display can be used as the monitor 130, the operation unit 140 being then constituted of the touch panel of this monitor 130.

On the other hand, in the printer 1, a printer control unit 200 for controlling each of the parts of the printer 1 in accordance with a command from the host computer 10 is also provided. The recording heads, the UV lamps, and each of the device parts in the sheet conveyance system are controlled by the printer control unit 200. The details of the manner in which the printer control unit 200 controls each of the device parts are as follows.

The printer control unit 200 control the ink ejection timing of each of the recording heads 51 for forming the color image, in accordance with the conveyance of the sheet S. More specifically, the control of the ink ejection timing is executed on the basis of an output (detection value) from a drum encoder E30 for detecting the rotational position of the platen drum 30, the drum encoder E30 being mounted onto a rotating shaft of the platen drum 30. Namely, because the platen drum 30 rotates reciprocatingly in association with the conveyance of the sheet S, the conveyance position of the sheet S can be ascertained when the output of the drum encoder E30 for detecting the rotational position of the platen drum 30 is referenced. In view thereof, the printer control unit 200 generates a pts (print timing signal) signal from the output of the drum encoder E30 and controls the ink ejection timing of each of recording heads 51 on the basis of the pts signal, whereby the ink having been ejected by each of the recording heads 51 is impacted onto a target position on the sheet S that is being conveyed, thus forming the color image.

The timing whereby the recording head 52 ejects the transparent ink, too, is controlled by the printer control unit 200 in a similar fashion on the basis of the output of the drum encoder E30. This makes it possible for the transparent ink to be accurately ejected onto the color image having been formed by the plurality of recording heads 51. The irradiation light intensity and timing of the turning on and off of the UV lamps 61, 62, 63 are also controlled by the printer control unit 200.

The printer control unit 200 also governs a function for controlling the conveyance of the sheet S, as described in detail with reference to FIG. 1. Namely, among the members constituting the sheet conveyance system, a motor is respectively connected to the supply spindle 20, the front drive roller 31, the rear drive roller 32, and the take-up spindle 40. The printer control unit 200 controls the speed and torque of each of the motors while causing the motors to rotate, and thus controls the conveyance of the sheet S. The details of this control of the conveyance of the sheet S are as follows.

The printer control unit 200 causes a supply motor M20 for driving the supply spindle 20 to rotate, and feeds the sheet S from the supply spindle 20 to the front drive roller 31. The printer control unit 200 herein controls the torque of the supply motor M20 to adjust the tension (supply tension Ta) from the supply spindle 20 to the front drive roller 31. Namely, a tension sensor S21 for detecting the supply tension Ta is mounted onto the driven roller 21 arranged between the supply spindle 20 and the front drive roller 31. The tension sensor S21 can be constituted of, for example, a load cell for detecting the force received from the sheet S. The printer control unit 200 carries out a feedback control of the torque of the supply motor M20 on the basis of a detection result from the tension sensor S21, and thus adjusts the supply tension Ta of the sheet S.

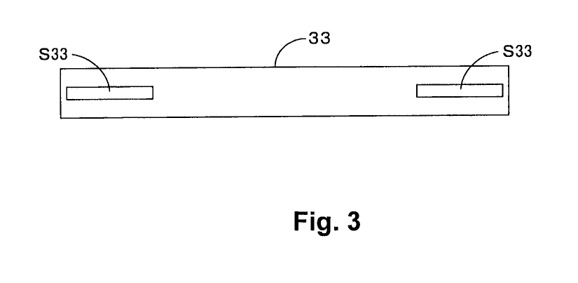

Herein, the printer control unit 200 causes the sheet S to be supplied while also adjusting the position, in the width direction, of the sheet S being fed from the supply spindle 20 to the front drive roller 31, so as to prevent the sheet S from suffering a misalignment in the width direction (the direction orthogonal to the paper in FIG. 1) and to prevent the tension being applied to the sheet S from being distributed in the width direction. Namely, a steering unit 7 for respectively displacing the supply spindle 20 and the driven roller 21 in the axial direction (in other words, the width direction of the sheet S) is provided to the printer 1. The operation of the steering unit 7 is controlled on the basis of detection results from two tension sensors S33 (FIG. 3) mounted onto the driven roller 33.

FIG. 3 is a drawing schematically illustrating an example of the arrangement of the tension sensors. As illustrated in FIG. 3, the driven roller 33 has the tensions sensors S33 mounted onto the two end parts thereof in the axial direction (in other words, the width direction of the sheet S). The tension sensors S33 are constituted of load cells for measuring the tensions of the sheet S at the respective mounting positions thereof. This makes it possible to detect the tension of the sheet S at a plurality of different positions in the width direction. Also, the printer control unit 200 carries out a feedback control of the steering unit 7 and adjusts the position of the sheet S in the width direction such that the difference between these detection values of the tension sensors S33 reaches zero. The position of the sheet S toward the width direction is thereby optimized, and a tension that is uniform in the width direction is thereby imparted to the sheet S.

The printer control unit 200 also rotates a front drive motor M31 for driving the front drive roller 31, and a rear drive motor M32 for driving the rear drive roller 32. The sheet S having been supplied from the supply unit 2 is thereby passed through the process unit 3. Herein, speed control is executed for the front drive motor M31, whereas torque control is executed for the rear drive motor M32. In other words, the printer control unit 200 adjusts the rotational speed of the front drive motor M31 to a constant speed, on the basis of an encoder output from the front drive motor M31. The sheet S is thereby conveyed at a constant speed by the front drive roller 31.

On the other hand, the printer control unit 200 controls the torque of the rear drive motor M32 and thus adjusts the tension (process tension Tb) of the sheet S from the front drive roller 31 to the rear drive roller 32. Namely, a tension sensor S34 for detecting the process tension Tb is mounted onto the drive roller 34 arranged between the platen drum 30 and the rear drive roller 32. This tension sensor S34 can be constituted, for example, of a load cell for detecting the force received from the sheet S. The printer control unit 200 also carries out feedback control of the torque of the rear drive motor M32 on the basis of a detection result from the tension sensor S34, and thus adjusts the process tension Tb of the sheet S.

The printer control unit 200 causes a take-up motor M40 for driving the take-up spindle 40 to rotate, and the sheet S conveyed by the rear drive roller 32 is taken up around the take-up spindle 40. Herein, the printer control unit 200 controls the torque of the take-up motor M40 and thus adjusts the tension (take-up tension Tc) of the sheet S from the rear drive roller 32 to the take-up spindle 40. Namely, a tension sensor S41 for detecting the take-up tension Tc is mounted onto the drive roller 41 arranged between the rear drive roller 32 and the take-up spindle 40. This tension sensor S41 can be constituted, for example, of a load cell for detecting the force received from the sheet S. The printer control unit 200 carries out a feedback control of the torque of the take-up motor M40 on the basis of a detection result from the tension sensor S41, and thus adjusts the take-up tension Tc of the sheet S.

Also, the printer control unit 200 controls the cooling fan 81 for cooling the platen drum 30, on the basis of a detection result from a temperature sensor S30. The temperature sensor S30 can be constituted of an infrared radiation thermometer or other contactless thermometer. As illustrated in FIG. 1, the temperature sensor S30 is arranged so as to face the outer peripheral surface of the platen drum 30, which is exposed at the release section Rb. Specifically, the temperature sensor S30 is arranged so as to detect the temperature of a range of the release section Rb spanning from after the sheet S has split away until the portion that faces the cooling fan 81. Also, in a case where the temperature detected by the temperature sensor S30 is a predetermined threshold value or greater, the printer control unit 200 operates the cooling fan 81 to cool the platen drum 30, but in a case where the temperature detected by the temperature sensor S30 is less than the threshold value, then the printer control unit 200 stops the cooling fan 81.

As has been described above, in the present embodiment, the sheet S is wound about and supported by the platen drum 30 rotating under the force of friction against the sheet S. With the configuration of such description, because the platen drum 30 supporting the sheet S rotates while following the conveyance of the sheet S, air can be prevented from infiltrating in between the platen drum 30 and the sheet S being thus conveyed, and the sheet S can be tightly contacted against the platen drum 30 at the portion wound about the platen drum 30. Also, because the platen drum 30 is cooled, the heat of the sheet S will be transferred to the platen drum 30 via the portion wound about and closely contacted against the platen drum 30. In addition thereto, in the present embodiment, the UV ink is cured by being irradiated with ultraviolet rays at the portion of the sheet S that is wound about the platen drum 30. As such, the heat generated by the UV ink in association with the curing by ultraviolet irradiation can be rapidly released to the platen drum 30 via the portion of the sheet S that is wound about the platen drum 30. Accordingly, the temperature elevation in the portion of the sheet S where the ink has been affixed can be reduced and the temperature distribution in the sheet S can be kept low; as a result, it becomes possible to suppress the occurrence of wrinkling in the sheet S, and to obtain a high-quality image.

With the configuration in which the platen drum 30 is made to follow the sheet S that is being conveyed, without slipping, the generation of frictional heat between the platen drum 30 and the sheet S can be suppressed. As such, an advantage emerges in that the cooling of the platen drum 30 can be executed effectively.

Also, in the present embodiment, the release section of the outer peripheral surface of the platen drum 30, where the sheet S is not wound therearound, is cooled by the cooling fan 81. The configuration of such description makes it possible for the platen drum 30 to be cooled directly without the sheet S being interposed in between, and thus makes it possible for the platen drum 30 to be cooled efficiently.

The configuration where the cooling fan 81 is arranged so as to face the release section Rb also has another advantage, which is as follows. Namely, as described above, the platen drum 30 rotates while following the conveyance of the sheet S. As such, the outer peripheral surface of the platen drum 30 having absorbed the heat of the UV ink at the winding section Ra where the sheet S is wound therearound passes through the release section Rb in association with the rotation of the platen drum 30, thereafter again arrives at the winding section Ra, and is subjected to heat dissipation from the UV ink. At this time, in order for the heat to be effectively dissipated, preferably, the outer peripheral surface of the platen drum 30 is cooled before again arriving at the winding section Ra. By contrast, in the present embodiment, because the outer peripheral surface of the platen drum 30 is cooled at the release section Rb prior to again arriving at the winding section Ra, it becomes possible for the heat of the UV ink to be dissipated thereafter in an effective manner.

It should be noted that the cooling of the platen drum 30 need not always be carried out. That is, in a case where the temperature of the platen drum 30 is sufficiently low, to the extent that heat is being dissipated from the sheet S to the platen drum 30, then the cooling of the platen drum 30 can be stopped, whereas in a case where the temperature of the platen drum 30 has reached a predetermined temperature or higher, the cooling of the platen drum 30 is carried out. In view whereof, in the present embodiment, the cooling fan 81 executes the cooling of the platen drum 30 in a case where the temperature detected by the temperature sensor S30 has reached a predetermined threshold value or higher. With the configuration of such description, the cooling of the platen drum 30 will not be performed unnecessarily, and the effect of successfully conserving power can be expected.

Preferably, as in the present embodiment, a uniform tension is imparted to the sheet S and the close contact between the sheet S and the platen drum 30 is enhanced when the sheet S is closely contacted against the platen drum 30 and heat is dissipated from the sheet S to the platen drum 30. However, in some cases when the sheet S is misaligned in the width direction orthogonal to the conveyance path Pc, the tension being applied to the sheet S is thereby distributed in the orthogonal direction.

By contrast, in the present embodiment, there are provided the plurality of tension sensors S33 for detecting the tension of the sheet S at respective, mutually different positions, at which the tension sensors S33 are arranged, in the width direction of the sheet S. The position of the sheet S in the width direction is adjusted on the basis of the detection results from each of the tension sensors S33. As such, a misalignment of the sheet S in the width direction can be corrected as appropriate, and the distribution of tension of the sheet S in the width direction can be suppressed. Accordingly, the close contact between the sheet S and the platen drum 30 can be enhanced, and the distribution of heat from the sheet S to the platen drum 30 can be promoted; as a result, it becomes possible to suppress the occurrence of wrinkling in the sheet S, and to obtain a high-quality image.

### Second Embodiment

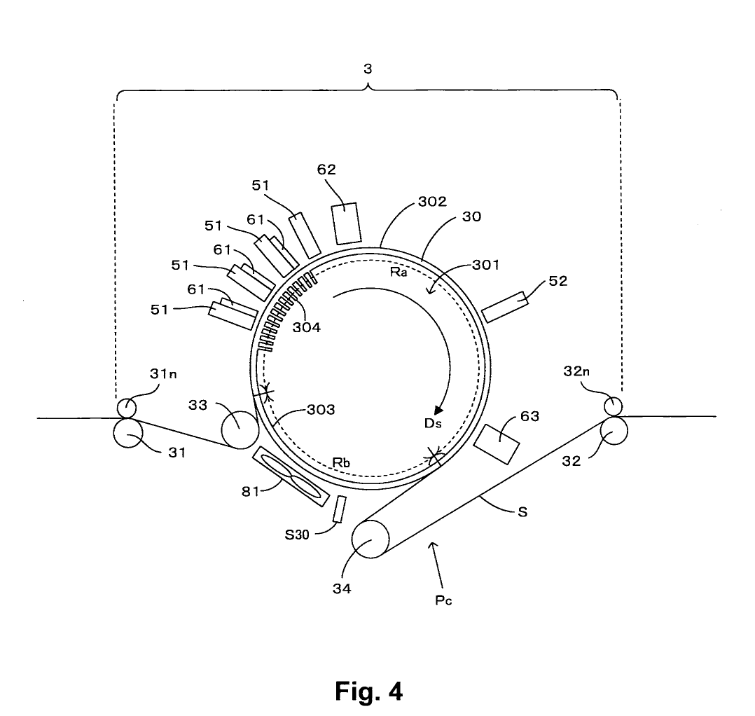

FIG. 4 is a front view schematically illustrating an example of a device configuration provided to a printer as in the second embodiment. The point of difference in the second embodiment from the first embodiment is primarily the configuration of the platen drum 30, and thus the following description centers on this different section; like portions have been assigned corresponding reference numerals, and a description thereof has been omitted as appropriate. However, it shall be readily understood that the second embodiment, too, being equipped with a configuration akin to that of the embodiment described above, thereby gives rise to an effect similar to that of the embodiment described above.

In the second embodiment, the platen drum is formed so as to be hollow, and a hollow part 301 (hollow portion) thereof opens in the axial direction of the platen drum 30. Although not depicted, a rotating shaft of the platen drum 30 is passed through the center portion of the hollow part 301. Also, an outer peripheral portion 302 of the platen drum 30 is supported by a plurality of ribs (not shown) extending radially from the rotating shaft, and is freely able to rotate with respect to the center of the rotating shaft.

A plurality of fins 304 are formed, lined up in the peripheral direction of the platen drum 30, on an inner wall 303 of the platen drum 30 of such description. Each of the fins 304 is formed so as to project out toward the central axis of the platen drum 30 from the inner wall 303. The fins 304 are illustrated in part in FIG. 4, but in actuality the fins 304 are lined up over the entire periphery of the platen drum 30.

The platen drum 30 configured in this manner rotates in association with the conveyance of the sheet S. As such, the plurality of fins 304 mounted side by side in the peripheral direction of the platen drum 30 rotate together with the platen drum 30. This causes the fins 304 to cut through the surrounding air, promotes the dissipation of heat from the fins 304, and makes it possible for the platen drum 304 to be cooled effectively. In particular in the second embodiment, the concomitant use of the fins 304 together with the cooling fan 81 makes it possible for the platen drum 30 to be cooled even more effectively.

Also, in the second embodiment, the platen drum 30 is formed so as to be hollow, and the fins 304 are formed on the inner wall of the platen drum 304. With the configuration of such description, there is no need for an arrangement space for the fins 304 to be provided to the outside of the platen drum 30, and a reduction in the size of the printer 1 can be successfully achieved.

### Third Embodiment

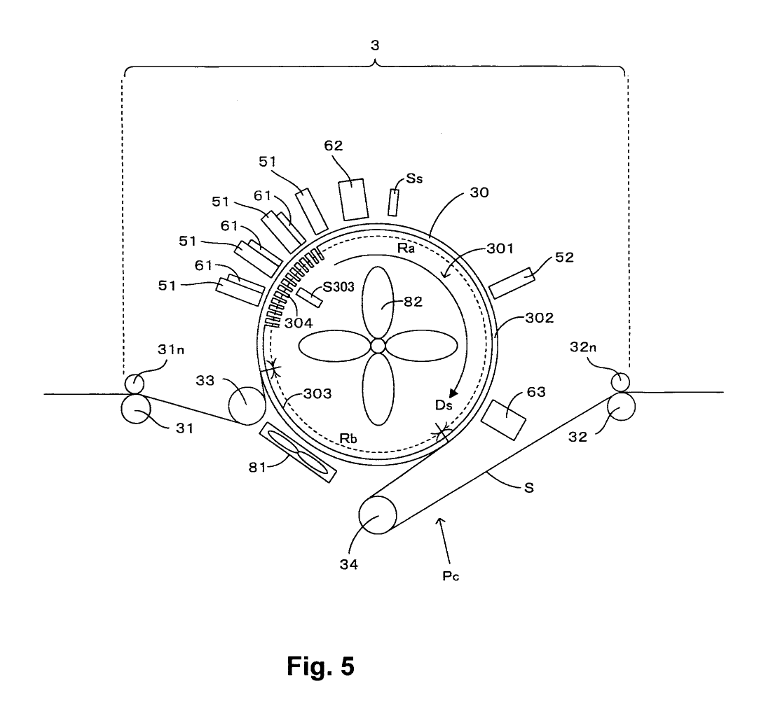

FIG. 5 is a front view schematically illustrating an example of a device configuration provided to a printer as in the third embodiment. The following description centers on the section of difference between the third embodiment and the embodiments described above; like portions have been assigned corresponding reference numerals, and a description thereof has been omitted as appropriate. It shall be readily understood that the third embodiment, too, being equipped with a configuration akin to that of the embodiments described above, thereby gives rise to an effect similar to that of the embodiments described above.

In the present embodiment, unlike in the embodiments described above, the temperature sensor S30 for detecting the temperature of the outer peripheral surface of the platen drum 30 is forgone, while a temperature sensor Ss for detecting the temperature of the front surface of the sheet S is provided. This temperature sensor Ss is constituted of an infrared radiation thermometer or other contactless thermometer, and detects the temperature of the front surface of the sheet S downstream of the UV lamp 62 in the conveyance path Pc. Also, the printer control unit 200 controls the cooling fan 81 for cooling the platen drum 30, on the basis of a detection result from the temperature sensor Ss. The control content at this time is similar to that from when the temperature sensor S30 described above is used, and thus a description has been omitted.

A cooling fan 82 faces the opening of the hollow part 301 of the platen drum 30. Air is blown into the hollow part 301 of the platen drum 30 by the cooling fan 82. This creates an air flow into the hollow part 301 of the platen drum 30, where the fins 304 have been provided, and further promotes the dissipation of heat from the fins 304, making it possible for the platen drum 30 to be more effectively cooled.

Herein, the blowing of air by the cooling fan 82 is controlled on the basis of a detection result from a temperature sensor 5303. The temperature sensor S303 is constituted of an infrared radiation thermometer or other contactless thermometer, and detects the temperature of the inner wall 303 of the platen drum 30. Also, in a case where the temperature detected by the temperature sensor S303 is a predetermined threshold value or greater, the printer control unit 200 operates the cooling fan 82 to cool the platen drum 30, but in a case where the temperature detected by the temperature sensor S303 is less than the threshold value, then the printer control unit 200 stops the cooling fan 82. This makes it possible for the cooling fan 82 to be operated as appropriate in accordance with the temperature of the inner wall of the platen drum 30, to effectively cool the platen drum 30.

### Other

As in the foregoing, in the embodiments described above, the printer fan 1 is equivalent to the “image recording device” of the invention; the sheet S is equivalent to the “recording medium” of the invention; the platen drum 30 is equivalent to the “drum” of the invention; the recording heads 51 are equivalent to the “ejection units” of the invention; the UV lamps 62, 63 are equivalent to the “light irradiation units” of the invention; the UV ink is equivalent to the “ink” of the invention; the cooling fan 81, the fins 304, or the cooling fan 82 are equivalent to the “cooling unit” of the invention; and the front drive roller 31, the rear drive motor 32, the front drive motor M31, the rear drive motor M32, and the printer control unit 200 function in cooperation as the “conveyance unit” of the invention. Also, the conveyance path Pc is equivalent to the “conveyance path” of the invention, and the width direction of the sheet S is equivalent to the “orthogonal direction” of the invention.

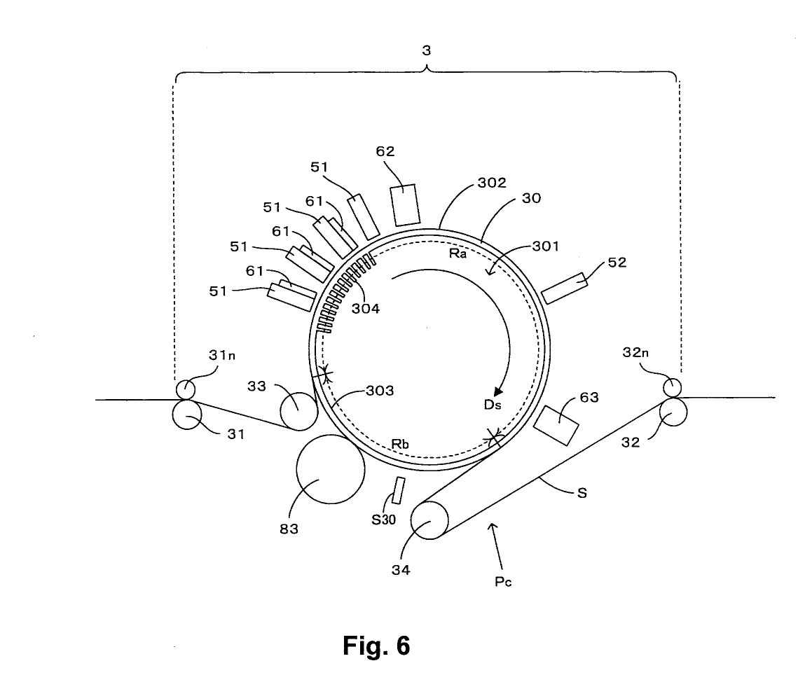

The invention is not to be limited to the embodiments described above; rather, a variety of different modifications can be added to what has been described above, provided that there is no departure from the spirit of the invention. For example, the configuration for cooling the platen drum 30 is not limited to what is described above, but rather can be modified in a variety of different possibilities. The cooling mechanism for the platen drum 30 could also be configured as in FIG. 6. Herein, FIG. 6 is a drawing schematically illustrating a modification example of the cooling mechanism for the platen drum. In FIG. 6, a cooling roller 83 (a contact roller) having a built-in heat pipe rotates following the platen drum 30 while also abutting against the outer peripheral surface of the platen drum 30 at the release section Rb. The platen drum 30 is cooled in this manner by the cooling roller 83. Herein, the cooling operation of the cooling roller 83 is controlled on the basis of the detection result from the temperature sensor S30. The control content at this time is similar to that from when the cooling fan 81 described above was used, and thus a description thereof has been omitted.

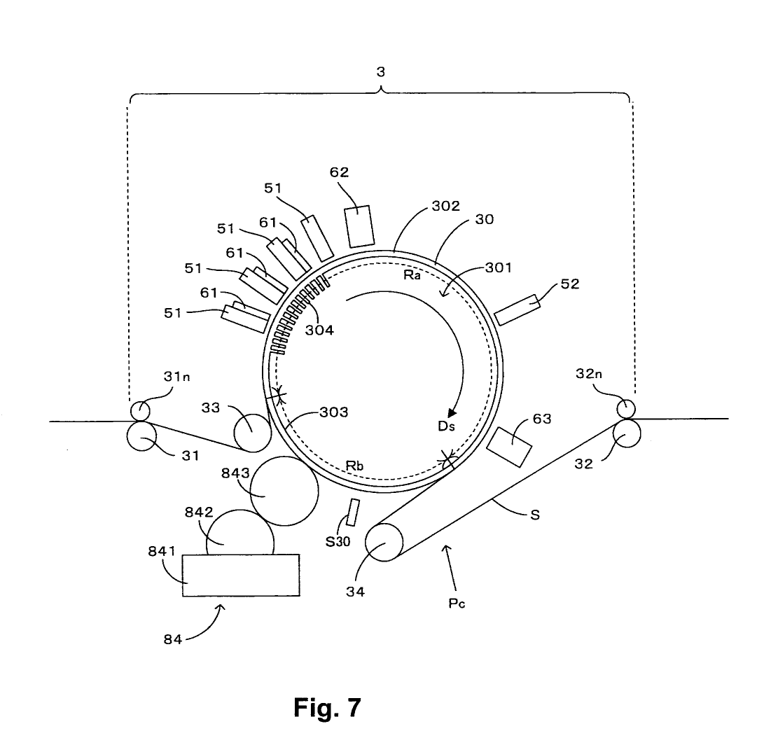

Alternatively, the cooling mechanism for the platen drum 30 could also be configured as in FIG. 7. Herein, FIG. 7 is a drawing schematically illustrating another modification example of the cooling mechanism for the platen drum. In FIG. 7, a liquid coating unit 84 is provided as a cooling mechanism for the platen drum. The liquid coating unit 84 has: a vessel 841 for storing alcohol, water, or another liquid; an supply roller 842 for drawing up the liquid inside of the vessel 841; and a coating roller 843 (a contact roller) for coating the outer peripheral surface of the platen drum 30 at the release section Rb with the liquid that has been drawn up by the supply roller 842. The platen drum 30 is cooled by the vaporization heat of the coated liquid.

In this configuration, it would also be possible to change the rotational speed of the supply roller 842 to adjust the amount of liquid that is drawn up by the supply roller 842 per unit time, thereby increasing or reducing the amount of liquid coated onto the platen drum 30 and controlling the degree to which the platen drum 30 is cooled. More specifically, the degree of cooling is controlled on the basis of the detection result from the temperature sensor S30. The control content at this time is similar to that from when the cooling fan 81 described above is used, and thus a description has been omitted.

The platen drum 30 can also be cooled by a configuration other than those illustrated in FIGS. 6 and 7. Specifically, the configuration can be such that heat piping is mounted onto the platen drum 30 itself, the platen drum 30 then being cooled by the heat piping.

Also, although above a variety of different mechanisms 81, 304, 82, 83, 84 for cooling the platen drum 30 have been mentioned, these can also be used in combination or can be used independently. As a specific example, in the second embodiment described above, the cooling fan 81 and the fins 304 are used together in combination. However, the configuration can also be such that the platen drum 30 is cooled by the fins 304 alone, without the use of the cooling fan 81.

In the embodiments described above, the operation timing of the cooling mechanisms 81, 82, 83, 84 for the platen drum 30 was controlled. However, the configuration could also be such that the cooling mechanisms 81, 82, 83, 84 are operated at all times, without there being any particular control therefor.

In the embodiments described above, the cooling mechanisms 81, 82, 83, 84 for the platen drum 30 were arranged with respect to the release section Rb. However, the positions of the cooling mechanisms 81, 82, 83, 84 are not limited thereto.

Neither the configurations nor positions of the variety of temperature sensors S30, S303, Ss described above are limited to the foregoing description, and modifications as appropriate are possible.

The installation position of the tension sensors S33 is also not limited to being the driven roller 33 as described above. As such, the tension sensors S33 can also be provided to the other members constituting the conveyance system of the sheet S.

Also, in the embodiments described above, the speed control was executed with respect to the front drive roller 31, and the torque control was executed with respect to the rear drive roller 32. However, the speed control can also be executed with respect to the rear drive roller 32, the conveying speed of the sheet S being determined from the rear drive roller 32, and the torque control can be executed with respect to the front drive roller 31, the tension Tb of the sheet S being adjusted by the front drive roller 31. The configuration can also herein be such that the sensor for detecting the tension Tb of the sheet S is provided to the driven roller 33.

The specific configuration of the steering unit 7 for adjusting the position of the sheet S in the width direction is also not limited to the foregoing description, and modifications as appropriate are possible. As such, the steering unit 7 can be constituted of a meandering control device as set forth in, for example, JP-B 4328043 or the like.

The invention is not to be limited to the embodiments described above; rather, a variety of different modifications can be added to what has been described, provided that there is no departure from the spirit of the invention. For example, provided that the recording medium is wound about the platen drum and is closely contacted with the outer peripheral surface of the platen drum, the platen drum can also be rotatably supported by a rotation support mechanism that includes a drive motor, being thereby controlled so as to rotate synchronously with the conveyance of the recording medium, instead of being driven and rotated under the force of friction with the recording medium being conveyed by the conveyor unit.

What is claimed is:

1. An image recording device, comprising:
a conveyor unit for conveying a recording medium;
a drum for rotating under the force of friction against the recording medium being conveyed by the conveyor unit, the recording medium being wound around an outer peripheral surface thereof;
an ejection unit for ejecting a photo-curable ink to record an image on a portion, of the recording medium, wound around the drum;
a light irradiation unit for irradiating the portion, of the recording medium, wound around the drum with light to cure the ink on the recording medium, downstream of the recording medium on a conveyance path with respect to the ejection unit; and
a cooling unit for cooling the drum.

2. The image recording device as set forth in claim 1, wherein
the cooling unit cools a non-winding portion of the outer peripheral surface of the drum, where the recording medium is not wound therearound.

3. The image recording device as set forth in claim 2, wherein
the cooling unit blows air with a fan onto the non-winding portion of the outer peripheral surface of the drum to cool the drum.

4. The image recording device as set forth in claim 1, wherein
the cooling unit has a contact roller that is in contact with the non-winding portion of the outer peripheral surface of the drum, and uses the contact roller to cool the drum.

5. The image recording device as set forth in claim 4, wherein
the cooling unit cools the drum using heat piping mounted onto the contact roller.

6. The image recording device as set forth in claim 4, wherein
the cooling unit coats the non-winding portion of the outer peripheral surface of the drum with a liquid using the contact roller and thereby cools the drum.

7. The image recording device as set forth in claim 1, further comprising:
a temperature detection unit for detecting the temperature of the recording medium having been irradiated with light by the light irradiation unit.

8. The image recording device as set forth in claim 2, further comprising:
a temperature detection unit for detecting the temperature of the non-winding portion of the outer peripheral surface of the drum.

9. The image recording device as set forth in claim 7, further comprising:
a control unit for controlling a cooling operation of the drum by the cooling unit, on the basis of a detection result from the temperature detection unit.

10. The image recording device as set forth in claim 9, wherein:
the control unit causes the cooling unit to execute the cooling of the drum in a case where the detection result from the temperature detection unit reaches a predetermined temperature or higher.

11. The image recording device as set forth in claim 1, wherein:
the cooling unit is constituted of fins mounted onto the drum, side by side in the peripheral direction of the drum.

12. The image recording device as set forth in claim 11, wherein:
the drum is formed so as to be hollow, and the fins are arranged on an inner wall of the drum.

13. The image recording device as set forth in claim 11, wherein:
the cooling unit has a fan for blowing air into the hollow portion of the drum.

14. The image recording device as set forth in claim 13, further comprising:
a temperature detection unit for detecting the temperature of the inner wall of the drum, and
a control unit for controlling the air-blowing of the fan of the cooling unit on the basis of a detection result from the temperature detection unit.

15. The image recording device as set forth in claim 1, further comprising:
a plurality of tension detection units for detecting the tension of the recording medium at respective, mutually different positions, at which the tension detection units are arranged, in the orthogonal direction orthogonal to the conveyance path of the recording medium; and
a position adjustment mechanism for adjusting the position of the recording medium in the orthogonal direction, on the basis of a detection result from each of the tension detection units.

16. An image recording method in which photo-curable ink is ejected onto a recording medium to record an image, while the recording medium is also being conveyed, and thereafter the recording medium is irradiated with light to cure the ink on the recording medium, the image recording method comprising:
a drum that rotates under the force of friction against the recording medium is cooled while a portion of the recording medium onto which the ink is ejected and a portion thereof that is irradiated with light are wound around and supported by an outer peripheral surface of the drum.

17. An image recording device, comprising:
a conveyor unit for conveying a recording medium;
a drum which is rotatably supported in a state where a predetermined tension has been applied to the recording medium and is rotated and driven so as to be synchronous with the recording medium, the recording medium being wound around the outer peripheral surface thereof;
an ejection unit for ejecting a photo-curable ink to record an image on a portion, of the recording medium, that is wound around the drum;
a light irradiation unit for irradiating the portion, of the recording medium, that is wound around the drum with light to cure the ink on the recording medium, downstream of the recording medium on a conveyance path with respect to the ejection unit; and
a cooling unit for cooling the drum.
